(19) United States
(12) Patent Application Publication
(10) Pub. No.: US 2011/0163937 A1
(43) Pub. Date: Jul. 7, 2011

(54) MULTIBAND ANTENNA USING ELECTROMAGNETIC COUPLING

(75) Inventors: Jong-Ho Jung, Yongin-si (KR); Won-hwi Jin, Seoul (KR); Byong-Nam Kim, Bucheon-si (KR)

(73) Assignee: ACE ANTENA CORP., Incheon-si (KR)

(21) Appl. No.: 13/062,809

(22) PCT Filed: Sep. 10, 2009
(86) PCT No.: PCT/KR2009/005143

§ 371 Date: Mar. 8, 2011

(30) Foreign Application Priority Data
Sep. 10, 2008 (KR) 10-2008-0089502

(51) Int. Cl. H01Q 21/30

(52) U.S. Cl. 343/893

(57) ABSTRACT

A multi-band antenna using electromagnetic coupling includes a first carrier; a first antenna pattern, which is formed on the first carrier and which includes a power feed part and a radiator part; a second carrier; and a second antenna pattern formed on the second carrier. The first and second carriers are arranged such that the first and second antenna patterns are separated by a particular distance, and the second antenna pattern is not connected to a ground or a power feed line but is formed independently on the second carrier to be fed by electromagnetic coupling with the power feed part of the first antenna pattern. Thus, the multi-band antenna can employ a single power feed setup. Also, the impact on the human body of the frequency signals generated by a terminal can be reduced, and property changes caused by the hand effect and the head effect can be minimized.

### TECHNICAL FIELD

The present invention relates to a multi-band antenna, more particularly to a multi-band antenna that uses electromagnetic coupling.

### BACKGROUND ART

With the recent trends towards providing multimedia and wide bands, mobile communication services are packing in more and more functions into the limited space of a mobile terminal. Furthermore, as the mobile communication terminal continues to decrease in size, it becomes increasingly difficult to design the antenna, and it has come to the point that the performance of the antenna determines the performance of the entire device.

Thus, there is increasing attention given to developing the antenna for mobile communication terminals, while the demands for the antenna are becoming more complex and the space provided for mounting the antenna is continuously being reduced. Moreover, current trends tend to build an internal antenna within the terminal, instead of having the conventional fixed-type antenna, which decrease convenience in carrying the terminal and also decrease its outward appearance. As such, there is a rapidly growing demand for the internal-type antenna. With the use of the internal antenna, however, certain problems have been identified during use in an actual environment, such as the hand effect and the head effect, and thus it has become necessary to take these problems into consideration when designing the internal antenna.

With the increase in use of the mobile communication terminal, there is also growing attention directed towards electromagnetic waves emitted from the terminal. In relation to this, the international community has set standards for the specific absorption rate (SAR) of electromagnetic waves for the human body, and the FCC of the United States has enforced similar regulations since 1997.

That is, the current mobile communication terminal must be designed such that it can handle signals of various bands in as small a size as possible while considering the hand effect, head effect, and electromagnetic waves.

FIG. 1 illustrates the structure of an antenna in a mobile communication terminal for providing multi-band services according to the related art.

Referring to FIG. 1, a mobile communication terminal for providing multi-band services according to the related art may include a first carrier 100, a first antenna 102, a second carrier 104, and a second antenna 106.

The pattern of the first antenna 102 is formed on the first carrier 100, while the pattern of the second antenna 106 is formed on the second carrier 104. The first carrier 100 is installed on a lower portion of the terminal, and the second carrier 104 is installed on a side portion of the terminal.

The first antenna 102 serves to send and receive signals of a preset first frequency band, while the second antenna 106 serves to send and receive signals of a preset second frequency band. Of course, at least one of the first and second antennas can operate as a multi-band antenna that sends and receives signals of two or more frequency bands, not just one. For example, the first antenna 102 may operate as an antenna that sends and receives signals of CDMA and PCS bands, while the second antenna 106 may operate as an antenna that sends and receives signals of a GPS band.

If an antenna is implemented in the manner shown in FIG. 1, then the first antenna and second antenna are installed independently, and thus the space occupied by the antennas within the terminal is inevitably increased. Also, as the power feed is performed independently, the power feed structure inevitably becomes more complicated. In addition, when two or more sets of power feed are used, the isolation problem is unavoidable between the first and second antennas installed within a limited space, and furthermore, the second antenna installed on a side portion of the terminal is placed near the hand or head of the user, making it vulnerable to the hand effect and head effect.

### DISCLOSURE

### Technical Problem

To resolve the problems described above, an objective of the present invention aims to provide a multi-band internal antenna that can be implemented in a small size and can utilize a single power feed setup.

Another objective of the invention is to provide a multi-band internal antenna that uses electromagnetic coupling.

Another objective of the invention is to provide a multi-band internal antenna with which the impact on the human body of the frequency signals generated in the terminal can be reduced and with which property changes resulting from the hand effect and head effect can be minimized.

Yet another objective of the invention is to provide a multi-band internal antenna that can be designed without having to consider isolation.

### Technical Solution

To achieve the objectives above, an aspect of the present invention provides a multi-band antenna using electromagnetic coupling that includes: a first carrier; a first antenna pattern, which is formed on the first carrier and which includes a power feed part and a radiator part; a second carrier; and a second antenna pattern formed on the second carrier. The first carrier and the second carrier are arranged such that the first antenna pattern and the second antenna pattern are separated by a particular distance, and the second antenna pattern is not connected to a ground or a power feed line but is formed independently on the second carrier to be fed by electromagnetic coupling with the power feed part of the first antenna pattern.

The second carrier can be installed on an opposite side to where the first carrier is installed in a terminal.

The first carrier can have a particular height, and the second carrier can be inserted beneath the first carrier.

The first antenna pattern may send and receive signals of a preset first frequency band, and the second antenna pattern may operate as a radiating element in a preset second frequency band by way of electromagnetic coupling power feed from the first antenna pattern.

The length of the second antenna pattern may be set to approximately ¼ of a center wavelength of the second frequency band.

When signals of the first frequency band are sent or received, the second antenna pattern may not affect radiation.

Another aspect of the invention provides a multi-band internal antenna using electromagnetic coupling that includes: a first antenna pattern, which includes a power feed part and a radiator part; and a second antenna pattern, which is arranged at a particular distance from the first antenna pattern, and which is formed independently without being joined to a ground or a power feed. Signals of a first frequency band and a second frequency band are fed to the power feed part, and when signals of the second frequency band are fed, the second antenna pattern is fed with signals of the second frequency band from the power feed part by way of electromagnetic coupling to operate as a radiator for signals of the second frequency part.

### Advantageous Effects

According to an aspect of the invention, the coupling phenomenon can be utilized such that the multi-band antenna uses a single power feed setup and is implemented in a smaller size.

Also, according to an aspect of the invention, the impact on the human body of the frequency signals generated by a terminal can be reduced, and property changes caused by the hand effect and the head effect can be minimized.

Furthermore, by using a single power feed setup and electromagnetic coupling to add the resonance for another band, the antenna can be readily designed without having to consider isolation between antennas.

### DESCRIPTION OF DRAWINGS

FIG. 1 illustrates the structure of an antenna in a mobile communication terminal for providing multi-band services according to the related art.

FIG. 2 is a top perspective view of a multi-band antenna using coupling according to a first disclosed embodiment of the invention.

FIG. 3 is a bottom perspective view of a multi-band antenna using coupling power feed according to the first disclosed embodiment of the invention.

FIG. 4 illustrates a second antenna pattern formed on a second carrier in a multi-band antenna according to the first disclosed embodiment of the invention.

FIG. 5 is a top perspective view of a multi-band internal antenna using coupling according to a second disclosed embodiment of the invention.

FIG. 6 illustrates how a second carrier is installed in a multi-band internal antenna using coupling according to the second disclosed embodiment of the invention.

FIG. 7 is a cross-sectional view of a multi-band internal antenna using coupling according to the second disclosed embodiment of the invention.

FIG. 8 represents the return loss during a hand-hold for a multi-band internal antenna using coupling according to the first disclosed embodiment of the invention.

FIG. 9 represents the return loss during a hand-hold for a multi-band internal antenna using coupling according to the second disclosed embodiment of the invention.

### MODE FOR INVENTION

The multi-band antenna using coupling according to certain preferred embodiments of the invention will be described below in more detail with reference to the accompanying drawings.

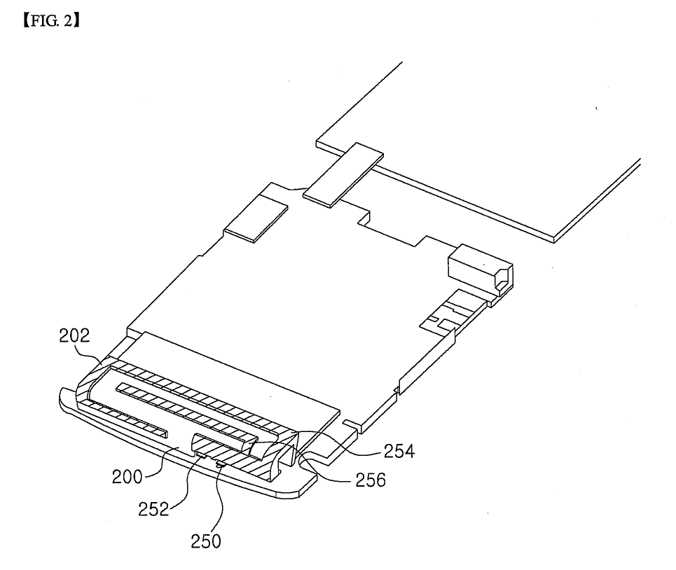

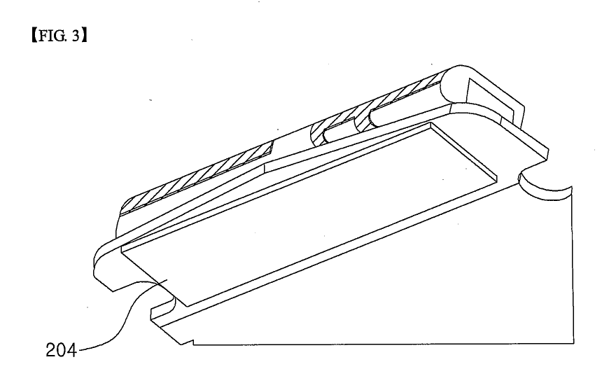

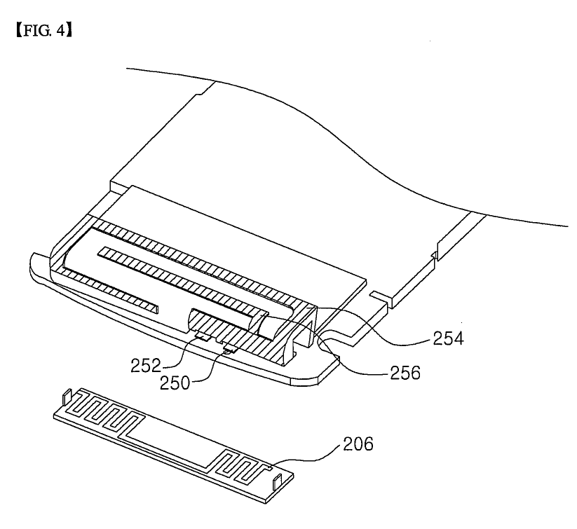

FIG. 2 is a top perspective view of a multi-band antenna using coupling according to a first disclosed embodiment of the invention, FIG. 3 is a bottom perspective view of a multi-band antenna using coupling power feed according to the first disclosed embodiment of the invention, and FIG. 4 illustrates a second antenna pattern formed on a second carrier in a multi-band antenna according to the first disclosed embodiment of the invention.

Referring to FIG. 2 through FIG. 4, a multi-band internal antenna using coupling according to a first disclosed embodiment of the invention may include a first carrier 200, a first antenna pattern 202, a second carrier 204, and a second antenna pattern 206.

The first carrier 200 may be installed in a particular position of a terminal, and the first antenna pattern 202 may be formed on the first carrier 200. The first carrier 200 may be made from a dielectric material. The first antenna pattern 202 can be formed on the first carrier 200 by a method such as heat fusion, bonding, ultrasonic fusion, etc. While FIG. 2 through FIG. 4 illustrate an example in which the first carrier is positioned at a lower end of the terminal, the position in which the first carrier is installed can be varied according to the structure of the terminal.

The first antenna pattern 202 formed on the first carrier 200 may serve to send and receive signals of a preset first frequency band.

According to an embodiment of the invention, the first antenna pattern 202 can be, but is not limited to, an antenna pattern that operates in a CDMA frequency band of 824 to 894 MHz and in a US PCS band of 1.85 to 1.99 GHz.

The first antenna pattern 202 can include a power feed part 250, a ground connection part 252, a low-band radiator part 254, and a high-band radiator part 256.

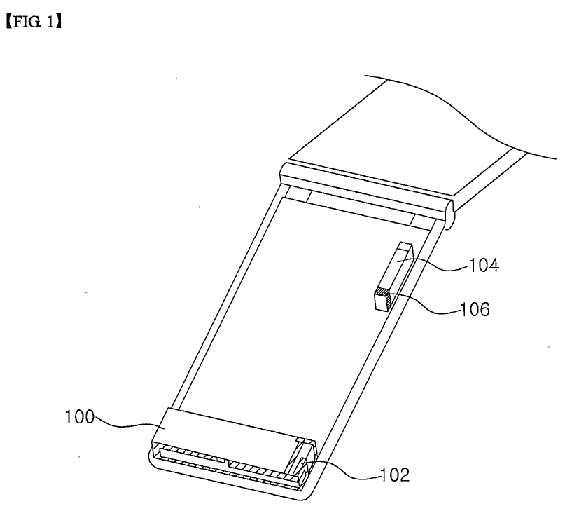

The power feed part 250 may be the part that is electrically connected with the power feed lines; and RF signals may be transferred to the antenna pattern through the power feed part 250. The ground connection part 252 may be the part that is electrically connected with the ground plane within the terminal. Whereas the antenna illustrated in FIG. 1 is a PIFA (planar inverted-F antenna) type antenna in which the radiator is joined with a ground and a power feed at a particular point, it will be apparent to those skilled in the art that the antenna pattern formed on the first carrier 200 is not limited to a PIFA antenna and that various types of antenna patterns can be formed, such as monopole type antennas, etc.

The first antenna pattern 202 illustrated in FIG. 2 is an antenna that can send and receive signals of a dual band (i.e. the first frequency band is a dual-band) and includes a low-band radiator part 254 and a high-band radiator part 256. According to an embodiment of the invention, the low-band radiator part 254 may send and receive signals of a CDMA band, while the high-band radiator part 256 may send and receive signals of a US PCS band. Of course, the first antenna pattern can also be an antenna that receives signals of a single band, unlike the one illustrated in FIG. 2.

Since the resonance band of the antenna is proportional to the length of the radiator, the length of the low-band radiator part 254 may be set to be longer than the length of the high-band radiator part 256.

The second carrier 204 may be installed on an opposite side with respect to the portion of the terminal at which the first carrier 200 is attached. That is, the second carrier 204 may be installed such that it is separated by a particular distance from the first carrier 200.

As illustrated in FIG. 4, the second antenna pattern 206 may be formed on the second carrier 204. The second carrier 204 may also be made of a dielectric material and may serve as the main body of the second antenna pattern. While FIG. 2 illustrates an example in which the second carrier 204 has the form of a board, the form of the second carrier can be changed in various ways.

The second antenna pattern 206 may receive second frequency signals from the power feed part of the first antenna pattern by way of electromagnetic coupling and may operate as a radiator for the second frequency signals.

The second antenna pattern may be formed on the second carrier 204 without being connected with the power feed line or the ground. With regards a conventional multi-band antenna, there exists the technology of forming multiple bands using the coupling of a parasitic pattern connected with a ground. In an embodiment of the present invention, however, the second antenna pattern is formed independently on the second carrier 204, without being connected with a ground, and receives coupling power feed from the power feed part of the first antenna.

While FIG. 4 illustrates an example in which the second antenna pattern is in the form of a meandering line, the shape of the antenna pattern is not thus limited, and various types of patterns can be formed.

When the signals of a first frequency, which is of the resonance band of the first antenna, are sent or received, the second antenna pattern 206 does not affect the operation or radiation of the first antenna. That is, when the signals of a first frequency are sent or received, the first antenna may operate, but there may be no electromagnetic coupling between the power feed part and the second antenna pattern, and thus the operation is similar to that case in which there is no second antenna pattern at all.

However, when the signals of a second frequency are sent or received, electromagnetic coupling is generated between the power feed part and the second antenna pattern, and the second antenna pattern may operate as an antenna that sends and receives signals for the second frequency band.

The length of the second antenna pattern may be set in correspondence to the second frequency. According to an embodiment of the invention, if the center frequency of the second frequency band is assumed to be λ₀, then the length of the second antenna pattern can be set to approximately 0.25 λ₀. Since the physical length and electrical length may vary according to the form of the pattern, however, the length of the second antenna pattern can slightly vary from 0.25 λ₀.

According to an embodiment of the invention, the second frequency band can be, but is not limited to, a GPS frequency band.

When using the related art, an example of which is illustrated in FIG. 1, sending and receiving signals of a triple band may require a GPS antenna and a CDMA/PCS antenna, as well as independent power feed. According to the example illustrated in FIG. 2 through FIG. 4, however, it is possible to form the antenna with a single power feed structure for signals of a triple band, and therefore the design of the multi-band antenna does not have to additionally consider isolation.

Also, since the power feed may be achieved in the form of coupling, the impact of the hand effect and the head effect, as well as the impact of electromagnetic waves, can be minimized.

Moreover, unlike the existing parasitic patch for forming multiple bands, the second antenna pattern formed independently does not give any influence in the first frequency band, so that the tuning for the second resonance band can be performed easily.

Furthermore, as the antenna for the triple band can be implemented as a single structure, the overall antenna size can be reduced.

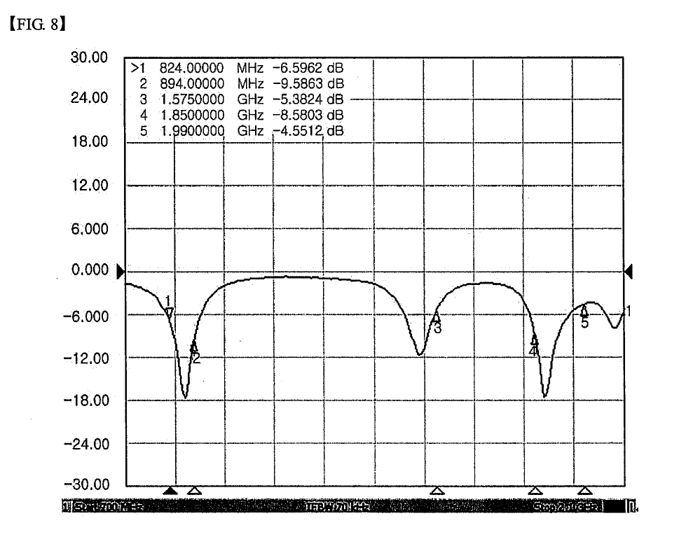

FIG. 8 represents the return loss during a hand-hold for a multi-band internal antenna using coupling according to the first disclosed embodiment of the invention.

In FIG. 8, the red line represents the return loss when there is no hand-hold, while the blue line represents the return loss when there is a hand-hold. As illustrated in FIG. 8, it can be seen that, when an antenna structure is used based on an embodiment of the invention, suitable resonance is obtained in the CDMA band (824 to 894 MHz), GPS band (1.575 GHz), and US PCS band (1.85 to 1.99 GHz), and there are slight changes in frequency properties for the GPS band during a hand-hold.

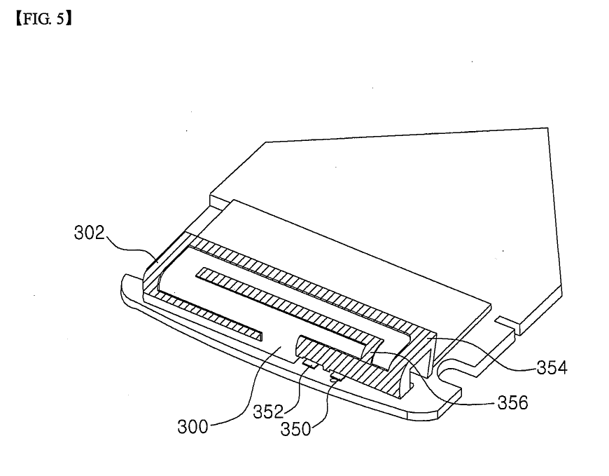

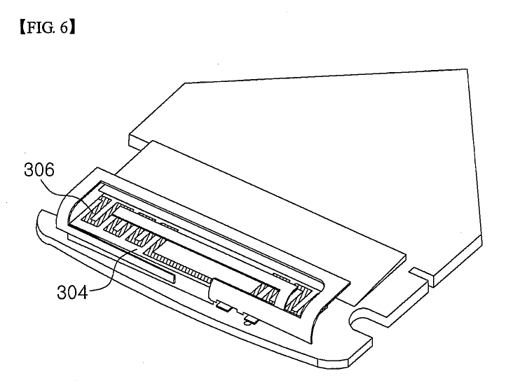

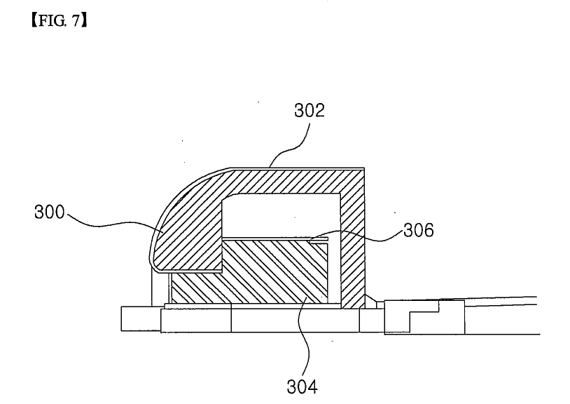

FIG. 5 is a top perspective view of a multi-band internal antenna using coupling according to a second disclosed embodiment of the invention, FIG. 6 illustrates how a second carrier is installed in a multi-band internal antenna using coupling according to the second disclosed embodiment of the invention, and FIG. 7 is a cross-sectional view of a multi-band internal antenna using coupling according to the second disclosed embodiment of the invention.

A multi-band internal antenna using coupling according to a second disclosed embodiment of the invention can include a first carrier 300, a first antenna pattern 302, a second carrier 304, and a second antenna pattern 306.

Referring to FIG. 5 through FIG. 7, the difference in the antenna of the second disclosed embodiment from that of the first disclosed embodiment is in the positional relationship between the first carrier and the second carrier. In the case of the first disclosed embodiment, the second carrier 204 may be installed on an opposite side to the portion where the first carrier is mounted. However, in the case of the second disclosed embodiment, the second carrier 304 may be installed in a lower part of the first carrier 300.

As illustrated in FIG. 5 through FIG. 7, the first carrier 300 may have a particular height and may be shaped with a portion rounded, such that a particular space may be formed in which to insert the second carrier.

The second carrier 304 may be inserted in the space formed at a lower part of the first carrier having a particular height.

The first antenna pattern 302 may be formed on the first carrier, and the second antenna pattern 306 may be formed on the second carrier 304. As in the first disclosed embodiment described above, the first and second antenna patterns 302, 306 can be formed on the first and second carriers 300, 304 by using a method such as heat fusion, bonding, ultrasonic fusion, etc.

Even when the first carrier 300 and second carrier 304 are arranged as in the example shown in FIG. 5 through FIG. 7, the first antenna pattern 302 and the second antenna pattern may be arranged with a particular distance in-between, so that it is possible to obtain electromagnetic coupling from the power feed part of the first antenna pattern 302 to the second antenna pattern.

The form of the first antenna pattern 302 may be substantially the same for the second disclosed embodiment as in the first disclosed embodiment. The first antenna pattern 302 may include a power feed part 350, a ground connection part 352, a low-band radiator part 354, and a high-band radiator part 356, and may operate as the antenna that resonates in a first frequency band (e.g. a CDMA band and a US PCS band). The second antenna pattern 306 formed on the second carrier 304 may not be electrically connected with the ground and power feed lines, instead being formed independently on the second carrier 304. As described above, the shapes of the first antenna pattern 302 and second antenna pattern 306 can be changed in various ways.

In the structure of FIG. 5 through FIG. 7 also, the first antenna pattern and the second antenna pattern may be arranged with a particular distance separating the two, and the second antenna pattern may operate as a coupling element in a second frequency band.

When signals for the first frequency band are sent or received, there may be no coupling generated between the first antenna pattern 302 and the second antenna pattern 306, because the length of the second antenna pattern does not allow resonance for the first frequency band. The first antenna pattern may send and receive signals for the first frequency band. When signals for the second frequency band are sent or received, the coupling phenomenon may be generated from the power feed part of the first antenna pattern 302 to the second antenna pattern 306, whereby the second antenna pattern 306 may operate as an antenna that sends and receives signals of the second frequency band.

As described above, the overall length of the second antenna pattern 306 can be set to approximately 0.25 λ₀ in order that radiation may be achieved in the second frequency band, and since the physical length and electrical length may vary according to the form of the pattern, the length of the second antenna pattern can slightly vary from 0.25 λ₀.

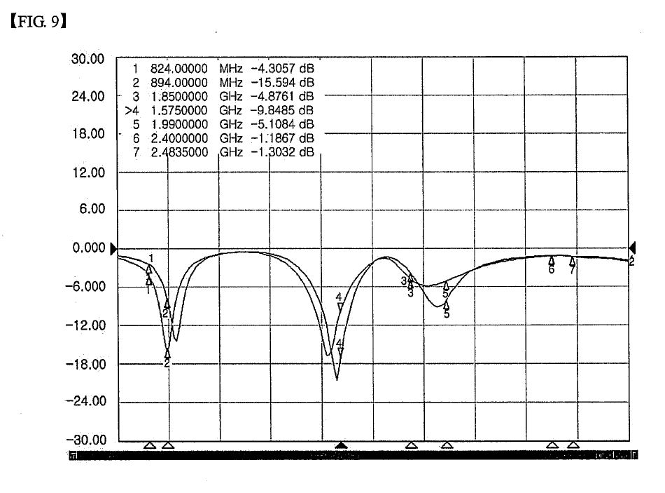

FIG. 9 represents the return loss during a hand-hold for a multi-band internal antenna using coupling according to the second disclosed embodiment of the invention. Referring to FIG. 9 it can be seen that resonance bands are formed in the CDMA band (824 to 894 MHz), GPS band (1.575 GHz), and US PCS band (1.85 to 1.99 GHz) for an antenna based on the second disclosed embodiment as well.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

1. A multi-band antenna using electromagnetic coupling, the antenna comprising:
a first carrier;
a first antenna pattern formed on the first carrier, the first antenna pattern comprising a power feed part and a radiator part;
a second carrier; and
a second antenna pattern formed on the second carrier,
wherein the first carrier and the second carrier are arranged such that the first antenna pattern and the second antenna pattern are separated by a particular distance, and the second antenna pattern is not connected to a ground or a power feed line but is formed independently on the second carrier to be fed by electromagnetic coupling with the power feed part of the first antenna pattern.

2. The multi-band antenna using electromagnetic coupling according to claim 1, wherein the second carrier is installed on an opposite side to where the first carrier is installed in a terminal.

3. The multi-band antenna using electromagnetic coupling according to claim 1, wherein the first carrier has a particular height, and the second carrier is inserted beneath the first carrier.

4. The multi-band antenna using electromagnetic coupling according to claim 1, wherein the first antenna pattern sends and receives signals of a preset first frequency band, and the second antenna pattern operates as a radiating element in a preset second frequency band by way of electromagnetic coupling power feed from the first antenna pattern.

5. The multi-band antenna using electromagnetic coupling according to claim 4, wherein a length of the second antenna pattern is set to approximately ¼ of a center wavelength of the second frequency band.

6. The multi-band antenna using electromagnetic coupling according to claim 5, wherein the second antenna pattern does not affect radiation when signals of the first frequency band are sent or received.

7. A multi-band internal antenna using electromagnetic coupling, the antenna comprising:
a first antenna pattern comprising a power feed part and a radiator part; and
a second antenna pattern arranged at a particular distance from the first antenna pattern, the second antenna pattern formed independently without being joined to a ground or a power feed,
wherein signals of a first frequency band and a second frequency band are fed to the power feed part, and when signals of the second frequency band are fed, the second antenna pattern is fed with signals of the second frequency band from the power feed part by way of electromagnetic coupling to operate as a radiator for signals of the second frequency part.

8. The multi-band internal antenna using electromagnetic coupling according to claim 7, wherein a length of the second antenna pattern is set to approximately ¼ of a center wavelength of the second frequency band.

9. The multi-band internal antenna using electromagnetic coupling according to claim 8, further comprising a first carrier and a second carrier, the first carrier having the first antenna pattern formed thereon, the second carrier having the second antenna pattern formed thereon.

10. The multi-band internal antenna using electromagnetic coupling according to claim 8, wherein the second antenna pattern does not affect radiation when signals of the first frequency band are sent or received.

11. The multi-band internal antenna using electromagnetic coupling according to claim 9, wherein the second carrier is installed on an opposite side to where the first carrier is installed in a terminal.

12. The multi-band internal antenna using electromagnetic coupling according to claim 9, wherein the first carrier has a particular height, and the second carrier is inserted beneath the first carrier.
